(19) United States
(12) Patent Application Publication
(10) Pub. No.: US 2008/0254765 A1
(43) Pub. Date: Oct. 16, 2008

(54) METHOD AND SYSTEM FOR MONETARY BILLING FOR THE USE OF CONTENT SERVICES IN INTERNET SITES, BY SENDING SMS MESSAGES FROM CELLULAR PHONES

(76) Inventor: Ari Eliaz, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/102,937

(22) Filed: Apr. 15, 2008

Related U.S. Application Data
(60) Provisional application No. 60/911,902, filed on Apr. 15, 2007.

(51) Int. Cl. H04M 11/00

(52) U.S. Cl. 455/406

(57) ABSTRACT

A system and method for billing web services provided by a service provider to a user. A server of the service provider is connected to a computerized terminal of the user, and to a telecommunication device of the user via a communication link. The system and method generate codes related to each user, web service and price for using the web service. The server sends the code and receives the code from the telecommunication device. Upon reception the server provides the web service to the user, and bill the price from the account of the telecommunication device.

### CROSS REFERENCE TO RELATED APPLICATIONS

This application claims the benefit of U.S. Provisional Patent Application 60/911,902, filed Apr. 15, 2007, which is incorporated herein by reference.

### FIELD OF THE INVENTION

The present invention generally relates to the field of billing. More particularly, the present invention relates to billing web services.

### BACKGROUND OF THE INVENTION

One of the most problematic issues facing Internet websites that wish to provide content and/or products in return for payment by users, and especially with regard to billing of small sums—(several cents or only a few dollars)—is finding a simple and efficient process with which to debit users for viewing content services or purchasing products. Existing processes currently require the user to execute a registration process in the website, receive a user name and password, as well as specify a payment method, such as: credit card, mailing of a check, standing order, debiting via the Internet provider or use of an electronic wallet such as PayPal, which also requires advanced registration. It is clear that many users are deterred by the need to execute a long process or to provide credit card details in order to receive a service whose cost is only a few cents. In addition, the economic expediency of executing a transaction whose cost is a few cents is doubtful, since often the fixed fee for credit card clearance is higher than the price of the service.

### SUMMARY OF THE INVENTION

The present invention discloses a system and method for billing at least one web service provided by a service provider to a user. The system comprises a server of the service provider, a computerized terminal of the user, and a telecommunication device of the user. The computerized terminal and the telecommunication device are connected via at least one communication link to the server. The server is enabled to send a code to the computerized terminal, wherein the code relates to the user, to the at least one web service and to a price for using the at least one web service. The server is further enabled to receive the code from the telecommunication device, provide the at least one web service to the user, and bill the price from the account of the telecommunication device. The method comprises the steps: sending and receiving a code to and from a user, wherein the sending is to a computerized terminal of the user, and receiving is from a telecommunication device of the user. Both sending and receiving are via at least one communication link. The code relates to the user, to the at least one web service and to a price for using the at least one web service. After receiving the code, the method comprises the steps of providing the at least one web service to the user and billing the user with the price via an account for the telecommunication device. In embodiments, the telecommunication device is a mobile device and the code is a word, sent as an SMS message to the server.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a block diagram of a system for billing web services provided by a service provider to a user, according to some embodiments of the invention.

FIG. 2 is a flowchart of a method for billing web services provided by a service provider to a user, according to some embodiments of the invention.

FIG. 3 is a block diagram of an example for a method for billing web services provided by a service provider to a user, according to some embodiments of the invention.

FIG. 4 is an example for a data table held at the server of the service provider, according to some embodiments of the invention.

### DETAILED DESCRIPTIONS OF SOME EMBODIMENTS OF THE INVENTION

The present invention discloses a system and method for billing web services provided by a service provider to a user. The system and method perform confirmation and acceptance of an order and a price in a single step and are especially efficient and practical for small sums of money.

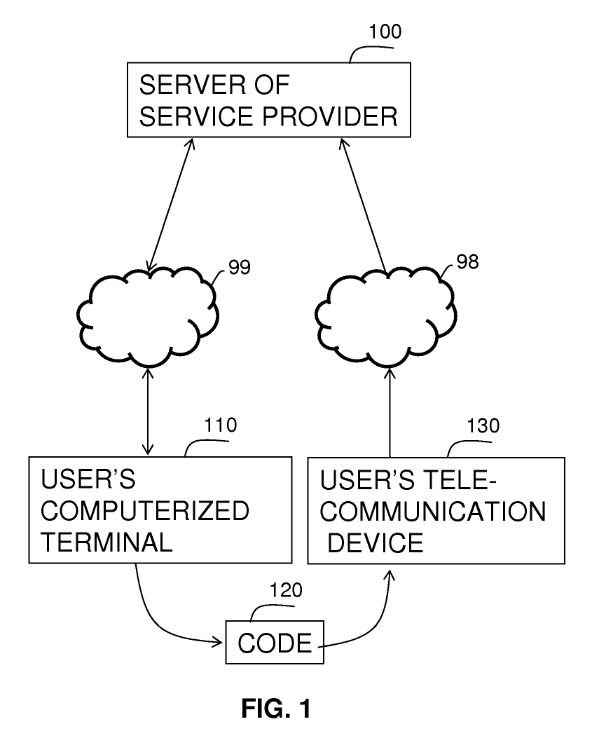

FIG. 1 is a block diagram of a system for billing web services provided by a service provider to a user, according to some embodiments of the invention. The system comprises a server 100 of the service provider connected to a user's computerized terminal 110 via a first communication link 99 and to a user's telecommunication device 130 via a second communication link 98. The server 100 sends user's computerized terminal 110 codes 120 for web services. The user may receive the web services by sending the server 100 the code 120 via the telecommunication device 130. The server 100 is enabled to receive the code 120 from the telecommunication device 130 via the second communication link 98, provide the web services, and bill the telecommunication account of the user.

According to some embodiments of the invention, the user's computerized terminal 110 may comprise a computer such as a desktop computer or a laptop; or a mobile device such as a personal digital assistant (PDA) or a mobile phone.

According to some embodiments of the invention, the user's telecommunication device 130 may comprise a mobile device such as a personal digital assistant (PDA) or a mobile phone; or a computer such as a desktop computer or a laptop; or a stationary device such as a telephone.

According to some embodiments of the invention, the code 120 may comprise a lexical word, allowing easier noting and entering the code. According to some embodiments of the invention, the code 120 may comprise a sequence of characters representing a word utilizing a predictive text technology (e.g. the word ‘home’ may be entered by pushing the keys ‘g-m-m-d’ on a mobile phone keyboard).

According to some embodiments of the invention, the code 120 may be valid for a predefined period only, for a specific web service, for a specific user or for a combination thereof. The user may pre-define the validity period and the number of web services the code stands for.

According to some embodiments of the invention, the system comprises a website that wishes to present content for payment, a billing and operation system comprising a central server and designated software, and a cellular provider, or subcontractor of cellular services. The billing system may comprise a software program that is capable of identifying a user code number and a unique number indicating the user's session at a specific time, the page where the user is located inside the provider's website, as well as other details and data contained in a table. An example for such a table is presented in FIG. 4.

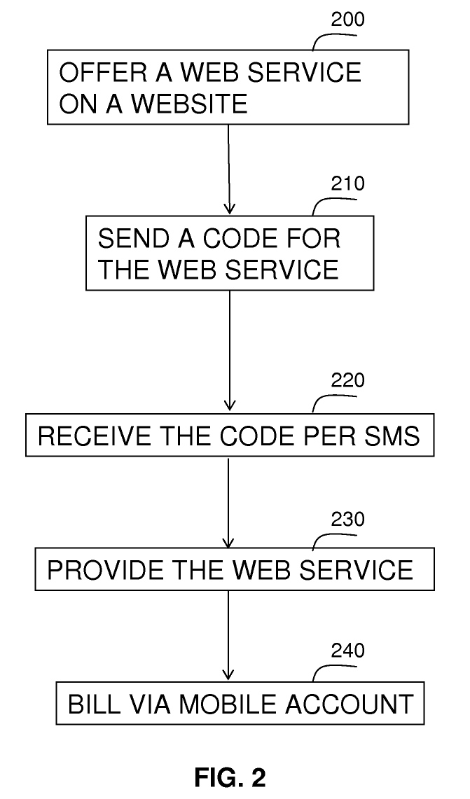

FIG. 2 is a flowchart of a method for billing web services provided by a service provider to a user, according to some embodiments of the invention. The method comprises the steps:
Offering a web service on a website (step 200).
Sending a code for the web service (step 210) via a first communication link to a computerized terminal of the user. The code may have a limited validity (e.g. a predefined period, one user, one session). One code may refer to a single web service or to a group of web services.
Receiving the code (step 220) via a second communication link from a telecommunication device of the user, e.g. as an SMS message from a mobile phone.
Providing the web service to the user (step 230).
Billing the user via an account for the telecommunication device (step 240).

According to some embodiments of the invention, sending a code may utilize security means such as a capture code.

According to some embodiments, the present invention discloses a method and system that enable immediate and efficient billing of Internet users for viewing content services on the Internet, in personal computers, without requiring the execution of a registration process (receipt of a user name and password) and without requiring the specification of a payment method, all in real time and in a user friendly manner, based on sending an SMS message via a cellular telephone. A user who wishes to view certain pages, which are blocked until payment is made, will be requested, after clicking a certain link that requires payment, to send an SMS message from his cellular phone, with a unique code word, to a certain number. Immediately upon receipt of this SMS message, the link on the website will be opened to the user without the need to enter any additional code in the computer.

Embodiments of the invention connect the cellular world with the non-cellular Internet world, in order to enable the opening of a link/application on the user's computer by sending an SMS message via the cellular network.

Due to the cumbersomeness of the billing and registration processes, many of the websites cannot provide content services in return for payment, and as a result their ability to create high quality content is impaired. According to some embodiments of the invention, the system integrates the popular terminal of SMS messaging over cellular networks with the regular world of Internet, and presents an efficient, immediate and easy solution for billing users for viewing content services on their personal computers over the Internet (as opposed to viewing content services over the cellular phone itself). It should be stressed that the term ‘content services’ also refers to the sale of products that are not actually content, such as software programs (downloads, etc.) and any other type of product. According to some embodiments of the invention, the method is very efficient for the execution of billing for small sums, from a few cents to a few dollars.

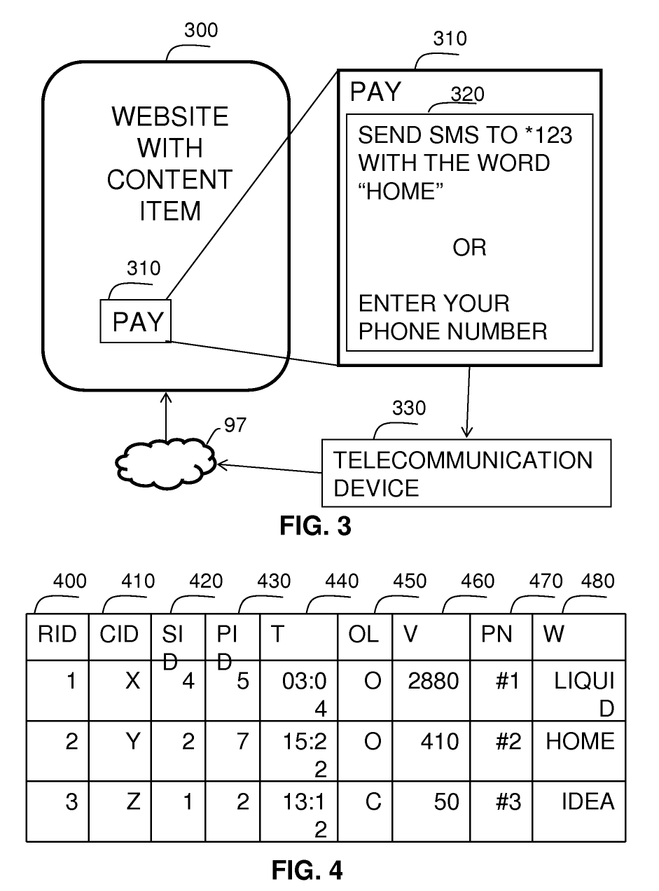

FIG. 3 is a block diagram of an example for a method for billing web services provided by a service provider to a user, according to some embodiments of the invention. A web site 300 may offer content items and other web services and enable payment 310 by either sending a word (e.g. “home”) as an SMS to a predefined phone number (e.g. *123) or entering a phone number for numbers saved in a database. The word is related to a user, a web service, a price, and possibly to the predefined phone number, and may be valid for a predetermined period of time. The word may be related to one content item, or to several content items or a web service. If the user chooses to pay for the content item, the user may send the specified word as an SMS, e.g. via a mobile device 330 via a communication link 97 to the service provider. Upon verification of the word, the content item is provided to the user and price is billed from the user's account for the mobile device. FIG. 3 exemplifies a simple process for selling small content items and web services without having to enter numbers of a credit card or a bank account, and without avoiding the risks of communicating of such data.

FIG. 4 is an example for a data table held at the server of the service provider, according to some embodiments of the invention. In this example the columns hold the following data: RID 400 holds a record identification number, UID holds a user identification number, SID 420 holds a session identification number, PID 430 holds a page identification number (SID 420 and PID 430 relate to the browsing activity of the user in the website and to the locations of the available web services). Further columns denote: T 440—the time of web service request, OL 450—whether the specific web service is available (O for open) or not (C for closed) to the user, depending on the provider's policy and the payment status of the user, V 460—the validity period of a specific code (e.g. in minutes), PN 470—the phone number of the user and W 480 the actual code related to the user, web service, price etc. (e.g. a word). Additional columns may comprise the price for each record, and columns control the actual payment. According to some embodiments of the invention the data table may hold data for several service provider, in which case an additional column may be added to the data table denoting the provider identification.

According to some embodiments of the invention, the provider may manage a database table, that will record, at any given moment, the user's details, usage time, session ID, page/link where the user is located at a certain moment, a column indicating which links are open to the user and which are closed to him (or default “Closed”) and the session ID of the rows in the table itself, as well as an additional cellular telephone number if they wish to open a link or website or region of a website to the user for a longer period of time then one session.

According to some embodiments of the invention, during the process of connection of the provider to the billing system, the provider is required to insert, in each page that contains content for which the provider wishes to demand payment, or in the entire website, several lines of code that are capable of identifying the data for the said table and sending the data to the billing system.

According to some embodiments of the invention, when the user clicks the link, this causes the sending of table data to the billing system. The billing system generates—for the number representing the ID of the row in the table (RID), relevant to the specific user at the specific time—a unique word or number, and sends an order display a window to the user, in which he is asked to send the unique word/number, via SMS, to a certain number. The message also specifies the cost for which the user will be billed for sending the SMS message, and the user is asked to click the link once again after sending the SMS message.

According to some embodiments of the invention, upon receipt of the SMS message, the billing system sends a message to the provider's server, that comprising SID 420, PID 430, T 440, OL 450—which link to open, V 460—for how long to open the link (until closing of the user's browser or any other time interval), RID 400, and the telephone number from which the SMS message was sent. After receipt of the reply, when the user clicks the link once again, the link opens or remains closed, as is defined in the OL 450 column.

According to some embodiments of the invention, if the provider wishes to allow the users to view the content for a period that is longer than the open session, for example 3 days, the time period that the service will remain open to the user is listed in the V 460 column.

According to some embodiments of the invention, when the user wishes to view the service once again, after the closing of the previous session, a window is opened and displayed to the user in which he is asked whether he has previously registered for the service, and if so, the user is asked to enter the cellular telephone number from which he sent the SMS, press “send”, and then click the desired link once again.

According to some embodiments of the invention, after sending the cellular telephone number, the provider's server verifies whether the cellular telephone number is registered in the system and its validity, and if the number is listed for the desired link and the service to the user is still valid (V 460), then when the link is pressed, the provider's server will open the link. If the cellular telephone number is not registered, or if the service has expired, a new window will be displayed to the user, informing him that the service has expired and asking him to send, via an SMS message from his cellular telephone, a specific word that will be displayed in the window, to a number that will also be displayed in the window. After the word is sent, registration is restarted as described above.

According to some embodiments of the invention, a user X clicks a link for a web service at a website of a service provider. The billing system code, which was inserted into the provider's page, identifies within a set time all the details appearing in the data table, and transmits to the billing system server the ID of the relevant record for the session of user X at that specific time (for example, record 1 in FIG. 4), and also, according to a requirement that is not a condition for provision of service, all the other details in the table, or part of them, for the purpose of internal administration of the billing system.

According to some embodiments of the invention, the billing system generates a unique code word, within a set time, for the ID of record 1 (for example, the word “Liquid”) and transmits this word to the billing window displayed to the user. The user is required to send the word “liquid” from his cellular telephone to a certain number, for example *123 and then click on the link once again. When the SMS message is received by the cellular provider, the message is transmitted to the billing system that includes the telephone number of the user the code word and time. The billing system converts the code word into a record ID, in this case=1, and sends a reply message to the provider, including the ID of the record—1, and the cellular telephone number of the user. The provider's server writes in the table, in record no. 1, an Open (O) order in the corresponding cell under the OL column 450 (which links are open to the specific user), and completes entry into the table (PN column 470) of the cellular telephone number from which the SMS message was sent.

According to some embodiments of the invention, another click by the user on the link initiates a check by the server in the table to verify that the specific user in record 1 is entitled to view the link. If “Open” appears under OL, the link opens, if not, a window is displayed informing the user that he must resend an SMS message with a unique word. If the user wishes to open the link again, after the closing of the previous session, a new window will be displayed in which the user is asked to enter the cellular telephone number from which the SMS message was sent, and then click the link once again. After sending the cellular telephone number, the provider's server checks whether the cellular telephone number appears in the table, and which link is listed next to this number, and if the link on which the user clicked is displayed as “Open”, or “O”. When the user clicks the link again it will open, if this cellular telephone number allows the opening of the specific link, if not the user will be asked to send a new SMS massage.

According to some embodiments of the invention, another possible option is that all the administration will be executed in the billing system server. In this case, the provider will send, at given time intervals, or with every click by any user or any link, all the table data dealing with user details, and in such a case the link verification according to the cellular telephone number will be executed by the billing system, that will send notification to the provider to open a specific link to a specific users, if this user is registered in the system and is authorized to view this link.

According to some embodiments of the invention, a code is embedded in the provider's page that enables sending of the details of a user who click on this page to the billing system. When a new user enters the website, a new record is added to the users' table in the provider's website. This record is registered with a unique session id (SID 420) for the user, as well as the page where he is located and the specific time. When the user enters a secured page, the relevant user record (SID 420) for the link where he is located (PID 430) is added, and the time at which he entered this link (T 440). If, under the same session id, the user has already entered the secured link, no record is created, but rather the record that contains the same session id and same link is updated—only with the relevant time (T 440).

According to some embodiments of the invention, the billing system code that is inserted into the page sends the billing system the number of the record that is relevant to this specific user from the users' administration table, and also inserts into the table, under the PID column 430, the link on which the user clicked or the details of additional links (the entire website or part of it) according to the provider's policy. The billing system identifies the provider's details according to the provider's domain (IP).

According to some embodiments of the invention, the billing system generates a unique word (code word) for the RID 400 whose number is 1, for example the word “Liquid”. The unique word generation process is executed using Ajax technology, and is transparent to the users who are not aware that their very entry into the secured page initiates access to the billing system that is located on a remote server. In other words, during no stage of the process described here does the user actually leave the provider's website.

According to some embodiments of the invention, the provider displays a window comprising the following content to the user: “Send an SMS message with the word “Liquid” to number *123 and click the link once again. You will be debited 1$ for this message.”, and “If you have already registered for the service, enter the cellular phone number from which you registered and click the link once again.”. If the user did not previously register and sends the word “Liquid” by SMS then the SMS message with the word “Liquid” is received by the cellular provider, who transmits the message details to the billing system: the code word “Liquid”, the time the message was received and the cellular telephone number from which the message was sent.

According to some embodiments of the invention, the billing system, based on the code word “Liquid” and the time the message was sent, is capable of reconverting the code word back to the details of the provider for whom the unique word “Liquid” was generated at the specific time (the system will not generate the same words for two providers at a given time, or at intervals that will be defined in advance) and the ID of the user. The billing system sends a message to the provider to insert into the table, according to the ID of record 1, the word Open under the OL column 450. When the user clicks the link again, the system checks whether for the user whose ID appears in record 1, an Open order exists under column OL 450, and if so the link is opened.

According to some embodiments of the invention, if the user is registered in the system, and requests to open the link in the provider's website after closing the browser, the window specified above will be displayed. The user will be asked to enter the cellular telephone number from which the SMS message was sent, to press “Send” and to click the link again. If, in the table, appearing next to cellular number is the link that the user clicked, and the prior registration is still valid (e.g. 2880 minutes, or two days have not yet elapsed), the provider's server will display the link to the user.

According to some embodiments of the invention, the service provider administers a providers table composed of the personal details and domain of the provider. In parallel, another table is administered, which is an actual billing table that is composed of the following columns:
Provider ID—a unique identification number for the provider.
RID—a column that corresponds to the users table in the provider's website.
Cell Phone—the cellular telephone number billed for the service.
Password—a column that administers the unique words that are generated by the billing system for the providers.
Request time—the time of the billing request.
Validity−the validity of the billing. A column that contains the exact date and time of service expiration.
Charged—whether billing was actually executed or not.
Amount to pay—the sum for billing the user (according to the terms set by the provider in his website).

According to some embodiments of the invention, when the user enters the secured link in the provider's website, a request is sent from the provider's website to the billing system. The billing system executed identification of the provider according to his domain and IP. If the provider is identified in the providers' table and his status is valid, the system generates a unique word—password. The system randomly retrieves a word and executes a check of the word to verify that it is not already in use in the billing table (Password). If so, the system generates a new word and executes a check once again, and so on and so forth. After a unique password has been generated for the provider, a new record is created in the provider's billing table, with the provider's data, RID, and other details. The Charged column is turned off. Once the user in the provider's website sends an SMS message, a message with the unique word is received by the provider's server. Verification is executed to check that the specific word is included in the billing table. If so, the provider's domain is identified, and a message is transmitted to the provider's website to open the link (RID). In parallel, the Charged column in the billing table is turned on, indicating that this provider was actually billed. The Validity column changes according to each provider and the provider's different requirements.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system for billing at least one web service provided by a service provider to a user, said system comprising:
a server of said service provider, providing said at least one web service,
a computerized terminal of said user, connected via a first communication link to said server,
a telecommunication device of said user, connected via a second communication link to said server,
wherein said server is enabled to send a code to said computerized terminal via said first communication link, wherein said code relates to said user, to said at least one web service and to a price for using said at least one web service;
and wherein said server is enabled to receive said code from said telecommunication device via said second communication link, provide said at least one web service to said user, and bill said price from the account of said telecommunication device.

2. The system of claim 1, wherein said code comprises a word.

3. The system of claim 1, wherein said computerized terminal comprises at least one of the following: a computer, a desktop computer, a laptop, a mobile device, a personal digital assistant (PDA), a mobile phone.

4. The system of claim 1, wherein said telecommunication device comprises at least one of the following: a mobile device, a personal digital assistant (PDA), a mobile phone, a stationary telephone, a computer, a desktop computer, a laptop.

5. The system of claim 1, wherein said code has a predefined period of validity.

6. A method for billing at least one web service provided by a service provider to a user, said method comprising:
sending a code to said user via a first communication link to a computerized terminal of said user, wherein said code relates to said user, to said at least one web service and to a price for using said at least one web service;
receiving said code via a second communication link from a telecommunication device of said user,
providing said at least one web service to said user,
billing said user with said price via an account for said telecommunication device.

7. The method of claim 5, wherein said receiving code utilizes an SMS.

8. The method of claim 5, wherein sending code utilizes security means.

9. The method of claim 7, wherein said security means are a capture code.

10. The method of claim 5, wherein said providing at least one web service and said billing are carried out only if said receiving code takes place before the end of a predefined period after said sending a code.
